(19) United States
(12) Patent Application Publication
(10) Pub. No.: US 2016/0136590 A1
(43) Pub. Date: May 19, 2016

(54) GAS/LIQUID MIXING APPARATUS

(71) Applicant: Prosper Brands LLC, Brooklyn, NY (US)

(72) Inventor: Wade Campbell, Fredericton (CA)

(21) Appl. No.: 14/941,013

(22) Filed: Nov. 13, 2015

Related U.S. Application Data
(60) Provisional application No. 62/123,284, filed on Nov. 13, 2014.

(51) Int. Cl. B01F 3/04; B01F 5/04

(52) U.S. Cl. CPC B01F 3/0446; B01F 3/04439; B01F 5/04

(57) ABSTRACT

An apparatus for mixing a gas and liquid comprising a mixing cylinder; a micromembrane and a sump. The gas is pressurized and introduced to the micromembrane for transfer to the liquid.

### CLAIM OF PRIORITY UNDER 35 U.S.C. §120

This application claims the benefit of priority to U.S. Prov. App. No. 62/123,284, entitled Gas/Liquid Mixing Apparatus, filed Nov. 13, 2014, the contents of which are incorporated herein by reference in their entirety.

### BACKGROUND

1. Field

This invention relates to an apparatus, system and method for mixing gas and fluid and more specifically saturating and super saturating a liquid with a gas, including oxygen infused water, nitrogen infused water, carbon dioxide infused water, oxygen-infused beverages, oxygen-infused therapeutic fluids, nitrogen-infused beverages, nitrogen-infused therapeutic fluids, carbon dioxide infused beverages, carbon dioxide infused therapeutic fluids, and other gas infused fluids.

2. Background

Approximately 1 in 17 persons are diagnosed with diabetes. Diabetes is considered a metabolic disease yet vascular problems are what cause more diabetic complications that reduce quality of life and longevity. One serious diabetic complication is the diabetic foot ulcer. Diabetic foot ulcers are any break in the skin although they usually extend through the full thickness of the skin and can involve deeper structures of the foot such as tendon and bone. The ulcers are painful, recurrent and slow to heal. Between 15 and 25% of all diabetics will be affected by foot ulcers in their lifetime and the clinical endpoint is often amputation of the affected toes, feet and lower limbs.

Previous attempts to saturate and supersaturate aqueous liquids with a gas have not been limited in the amount of gas that can be saturated and held in the liquid under atmospheric conditions. For example, previous attempts to supersaturate water with oxygen have not been able to hold more than 20 ppm to a high end of 30 ppm under atmospheric conditions. Moreover, supersaturated aqueous fluids tend to have an effervescence or bubbly quality. It would be desirable to have a system, apparatus, and method of mixing gas with liquid to produce a supersaturated liquid above 20 ppm that is free of an effervescent quality that held the elevated saturation levels in solution under normal atmospheric conditions.

### SUMMARY

Example embodiments disclosed herein are generally directed to an apparatus comprising a housing, a central tube within the housing for receiving and discharging a fluid, a plurality of micro-membranes arranged around the central tube and within the housing, a pressurized gas supply for delivering pressurized gas to the plurality of micro-membranes, and a sump for collecting fluid after gas saturation.

In another example embodiment disclosed herein the apparatus of the present invention includes an elongated cylindrical housing or tank with plugs at the top and bottom ends thereof; a central tube extending between the plugs for receiving a liquid and discharging the liquid into the top of the housing; a disc mounted on the upper end of the tube; and a plurality of hollow microporous fibers extending through and suspended from the disc for receiving a pressurized gas from a source thereof, whereby the gas flows through the fibers and the liquid flowing in the same direction as the gas collects the gas from pores in the fibers. When the liquid exits the area of the housing containing the fibers, it enters a fiber-free sump area where the excess gas which is not completely dissolved in the liquid coalesces and collects in the center of the housing beneath the fibers. The gas saturated liquid is discharged through an outlet in the bottom plug. The excess gas enters the central tube through an orifice beneath a tube plug and is discharged through a separate outlet in the bottom plug.

In yet another example embodiment a mixing apparatus for saturating a liquid with a gas, comprises: a pressure tank having an internal volume; a micromembrane structure within the internal volume of the pressure tank, the micromembrane configured to receive a gas under pressure; a fluid within the pressure tank and in contact with an outer surface of the micromembrane; a sump configured to receive the fluid such that the fluid is no longer in contact with the micro membrane.

Example embodiments may include on or more of the following features.

The pressure tank further comprises on or more fluid supply valves and one or more pressurized gas supply valves, a gas discharge valve, and/or a sump for releasing unused gas from the fluid, a fluid discharge line in communication with the sump. The micromembrane comprises a pore pathway diameter of about 0.01 μm to about 5 μm. The mixing apparatus is configured to receive two or more gases under pressure.

In yet another example embodiment, a method of mixing a gas and liquid comprises the steps of: (a) introducing a liquid to an interior chamber of a gas/liquid mixture cylinder, wherein the gas/liquid mixture cylinder comprises a micromembrane within an inner chamber; (b) introducing a pressurized gas to the micromembrane; (c) transferring at least a portion of the pressurized gas from the micromembrane to the liquid until the liquid has a dissolved gas concentration of 10 ppm or more; (d) holding the liquid in a sump within the mixture cylinder such that the liquid is not in contact with the micromembrane; and (e) removing the liquid from the sump. The pressurized gas is displaced within the micromembrane with a second pressurized gas. The pressurized gas is oxygen, nitrogen, or carbon dioxide.

In one example implementation of the present invention, a system for producing oxygen infused distilled spirits comprises a compressed oxygen cylinder, a gas infusion chamber in communication with the compressed oxygen cylinder, wherein the infusion chamber comprises a micromembrane having a pore channel diameter of between 0.05 and 5.0 μm, and a distilled spirit within the gas infusion chamber wherein the distilled spirit comprises an oxygen saturation greater than 30 ppm.

In yet another example implementation of the present invention a method of infusing oxygen in a distilled spirit comprises the steps of: (a) containing a distilled spirit within an oxygen infusion chamber; wherein the oxygen infusion chamber comprises a micromembrane having a pore channel diameter of between 0.05 and 5.0 μm; (b) pressurizing the oxygen infusion chamber with pure oxygen to an internal pressure of between 15 psi and 100 psi; (c) saturating the distilled spirit with oxygen until a level greater than 30 ppm oxygen is reached; and (d) removing the oxygen saturated distilled spirit from the oxygen infusion chamber.

In still another example implementation of the present invention, a system for producing a gas infused fluid comprises a compressed oxygen source, a gas infusion chamber for receiving the fluid, wherein the gas infusion chamber is in communication with the compressed oxygen cylinder; and a micromembrane in the gas infusion chamber, wherein the micromembrane has a pore channel diameter of about 0.05 μm to about 5.0 μm. The fluid is a beverage. The beverage comprises ethanol. The fluid is a distilled spirit. The distilled spirit is selected from the group consisting of: gin, rum, bourbon, cognac, tequila, whiskey, brandy, grappa, vodka, and a liqueur. The beverage is beer. The beverage is wine. The beverage is a nutritional beverage. The fluid is a therapeutic fluid. The fluid comprises at least about 15 ppm of oxygen, at least about 25 ppm of oxygen, at least about 30 ppm of oxygen, at least about 50 ppm of oxygen, at least about 75 ppm of oxygen. at least about 100 ppm of oxygen, at least about 150 ppm of oxygen, at least about 200 ppm of oxygen. The fluid comprises more than 200 ppm of oxygen. The system comprises a compressed nitrogen source. The system comprises a fluid supply pump in communication with the gas infusion chamber. The system comprises a holding chamber in communication with the gas infusion chamber. The gas infusion chamber is housed within the holding chamber. The system comprises a supply pump in communication with the holding chamber and the gas infusion chamber. The system comprises a distiller in communication with the gas infusion chamber. The system comprises a chiller in thermal communication with a supply line, wherein the supply line is in fluid communication with the gas infusion chamber.

In a further example implementation of the present invention, a method of infusing oxygen in a distilled spirit comprises the step of: (a) containing a fluid within a gas infusion chamber; wherein the gas infusion chamber comprises a micromembrane having a pore channel diameter of about 0.05 μm to about 5.0 μm; (b) pressurizing the gas infusion chamber with oxygen gas; (c) contacting the fluid with the oxygen gas in the gas infusion chamber to provide an oxygenated fluid comprising at least about 25 ppm of oxygen; and (d) removing the oxygenated fluid from the gas infusion chamber. The gas infusion chamber is pressurized to about 15 psi to about 100 psi. The fluid in the gas infusion chamber is circulated. The step of circulating comprises passing the fluid from a holding tank through the gas infusion chamber a plurality of times. The method further comprising releasing the oxygen gas from the gas infusion chamber and pressurizing the gas infusion chamber with a second gas. The second gas is nitrogen or carbon dioxide. The further comprising releasing the second gas from the gas infusion chamber and pressurizing the gas infusion chamber with a third gas, wherein the third gas is different from the second gas. The third gas is carbon dioxide or nitrogen. The method further comprises heating the fluid. The method further comprises cooling the fluid.

Aspects, embodiments and implementations provide the advantage of being able to transport Oxygen to a wound site independently of the vascular system, thereby benefiting the healing process.

### BRIEF DESCRIPTION OF THE DRAWINGS

FIG. 1 is a side view of a gas/liquid mixing apparatus in accordance with the invention;

FIG. 2 is a longitudinal sectional view of the upper end of the apparatus of FIG. 1;

FIG. 3 is a longitudinal sectional view of the lower end of the apparatus of FIG. 1;, and

FIG. 4 is an isometric view of the bottom end of a barrel and central tube used in the apparatus of FIGS. 1 to 3. FIGS. 2A-C illustrate PO2 at various times of an example method of the present invention;

### DETAILED DESCRIPTION

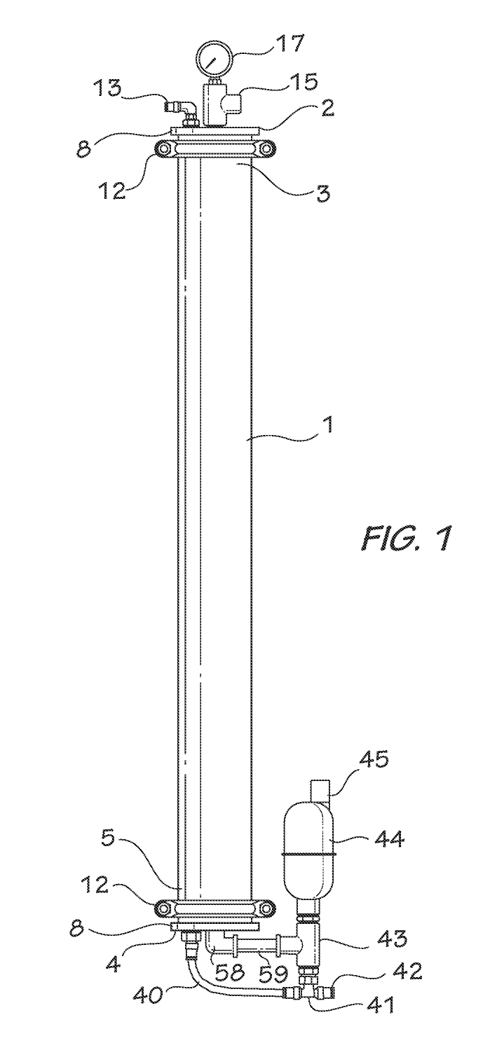

With reference to FIGS. 1 to 3, the mixing apparatus includes a thin-walled, tubular, stainless steel housing 1 with an inlet plug 2 in the top end 3 and an outlet plug 4 in the bottom end 5 thereof. Flanges 6 and 7 are provided on the top and bottom ends 3 and 5, respectively, of the housing 1. The plugs 2 and 4 are sealed in the housing 1 by O-rings 8. The plugs 2 and 4 are identical, each including a pair of spaced apart flanges 9 and 10 with an annular groove 11 therebetween. The flanges 10 act as seats for two-piece clamps 12, which clamp the plugs 2 and 4 in the housing 1.

Gas is introduced into the top end 3 of the housing via an elbow 13 and an inlet passage 14 in the plug 2. Liquid is introduced into the housing 1 via a T-coupling 15 and an inlet passage 16 in the center of the plug 2. A pressure gauge 17 mounted on the T-coupling 15 monitors the pressure of liquid entering the housing 1.

Liquid entering the inlet passage 16 flows through a short coupler 19 into a central tube 20 or core extending substantially the entire length of the apparatus.

The top end of the coupler 19 is sealed in the plug 2 by o-rings 21. The liquid is discharged from the tube 20 through four ports 23 into the housing 1. A plug 24 in the tube 20 beneath the ports 23 prevents the liquid getting past the ports. The top end of the tube 20 extends through and is connected to an epoxy resin disc 25, which is mounted in the top end of a cpvc sleeve 26. The sleeve 26 is sealed in the housing 1 by an O-ring 28.

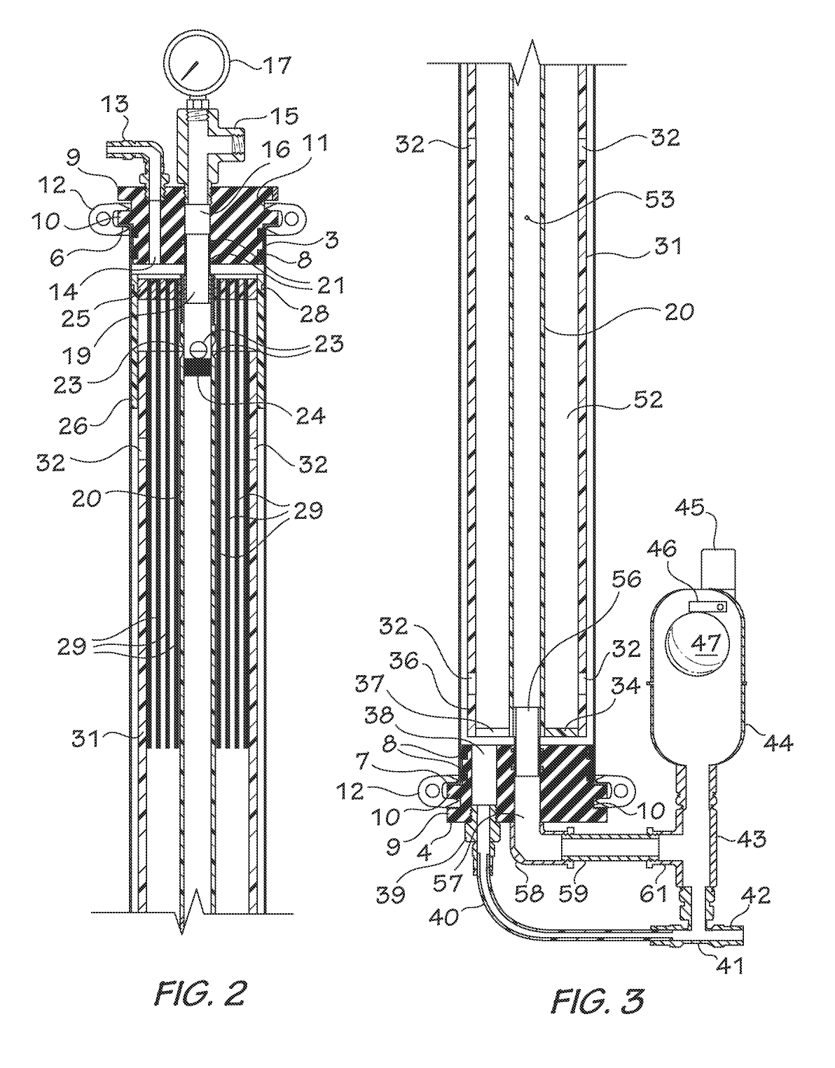

A plurality of hollow, microporous fibers 29 of the type described in U.S. Pat. No. 7,537,200, which issued to Craig L. Glassford on May 26, 2009, and incorporated herein by reference in its entirety, extend through and are suspended from the disc 25. The illustration of the fibers 29 in FIG. 2 is merely schematic. In an example implementation, an approximately 40 inch long housing 1, may include as many as 5,600 fibers 29 having a length of 14 inches and an outside diameter of 0.54 mm. The fibers 29 have a liquid repellent outer surface. A cpvc barrel 31 is mounted in and extends downwardly from the sleeve 26. The barrel 31 is spaced apart from the housing 1. Openings 32 in the barrel 31 permit liquid to enter the space between the housing 1 and the barrel.

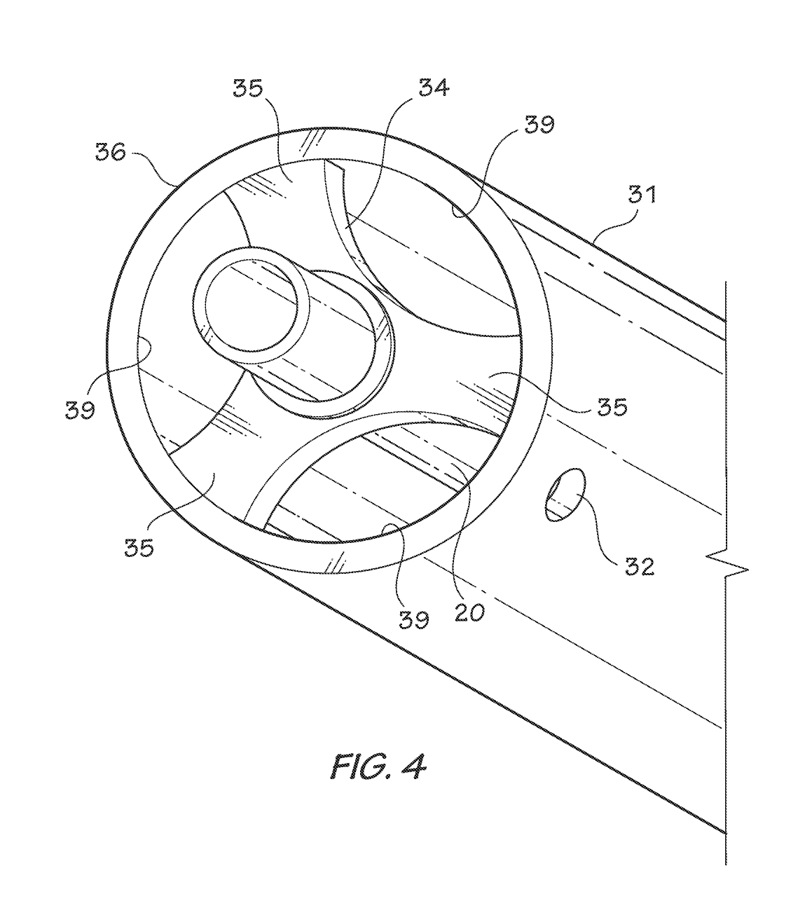

The bottom end of the central tube 20 extends through and is supported by a trefoil base 34 (FIG. 3), the arms 35 of which are connected to the open bottom end 36 of the barrel 31. Gaps 37 between the arms 35 provide outlets from the barrel 31 for liquid. Liquid discharged from the barrel 31 passes through an outlet passage 38 in the bottom plug 4, a coupling 39 and a polyethylene tube 40 to a T-coupling 41. The gas saturated liquid is discharged through one arm 42 of the coupling 41. Undissolved gas from the liquid entering the coupling 41 passes through another T-coupling 43 to a tank 44 for discharge through a gas vent valve 45. Opening and closing of the valve 45 is controlled by a lever 46 in the tank 44 operated by a float 47.

Undissolved gas in a sump area 52 beneath the fibers 29 passes through a small orifice 53 (FIG. 2) in the central tube 20 below the area in the barrel 31 containing the microporous tubes 29. The orifice 53 acts to control the level of undissolved gas and the liquid level in the barrel 31. The orifice 53 also prevents gas from exiting the liquid outlet passage 39 with the liquid by venting a controlled quantity of gas while simultaneously controlling the level of the gas/liquid interface in the apparatus. The gas density is lower than that of the liquid and preferentially passes through the orifice 53. In testing, it has been observed that the liquid may not be able to contain all of the gas in solution at this point, and excess gas which is not completely dissolved in the liquid will exit through the orifice 53.

Gas entering the central tube 20 through the orifice 53 is discharged through a short coupling 56, which connects the tube 20 to an outlet passage 57 in the bottom plug 4. The gas flows through the passage 57, and elbow 58 and a pipe 59 to the third arm 61 of the T-coupling 43.

In operation, liquid from a source thereof enters the apparatus via the T-coupling 15, inlet passage 16, coupler 19 and the central tube 20. The liquid is discharged from the tube through the four ports 23 and is distributed over the external surfaces of the microporous hollow fibers 29. At the same time, gas enters the apparatus via the elbow 13 and the inlet passage 14. The gas flows into the open top ends of the microporous hollow fibers 29 while the liquid is being distributed over the external surface of the fibers 29 in a co-current direction with the gas. The liquid continues to be in contact with the gas escaping through pores (not shown) in the microporous fibers 29, whereby the liquid collects gas into solution as it travels downwardly in the barrel 31. When the liquid exits the area of the barrel 31 containing the fibers 29, it enters the sump area 52 (FIG. 2) where excess gas which is not completely dissolved coalesces and collects in the center of the barrel 31. The gas saturated liquid is discharged through the outlet passage 39 in the plug 4, the tube 40 and the T-coupling 41.

When liquid is initially introduced into the apparatus, the apparatus is completely filled with ambient air. The air is vented through the tank 44 and the valve 45 by the introduction of liquid into the system. The liquid rises in the tank 44 to close the valve 45 preventing liquid from escaping. The orifice 53 in the central tube 20 maintains equilibrium of the gas/liquid in the area of the microporous fibers 29 and the bottom area of the barrel 31 which contains higher levels of gas saturation than the top of the barrel.

Gas entering the orifice 53 and the valve 45 after the apparatus reaches an equilibrium state leaves liquid that may contain less gas which allows more soluble gas to be infused into the liquid. The gas outlet T-coupling 43 allows liquid collected by the orifice to re-enter the main water outlet stream passing through the coupling 41 and vents gas coming out of solution due to turbulence in the liquid outlet. Moreover, the T-coupling 43 prevents hydraulic locks in the tank 44 by connecting the tank to the liquid stream flowing through the coupling 41. The polyethylene tube 40 through which liquid is discharged from the apparatus is sized to allow a specific amount of pressure to be held in the gas infusion apparatus at a specific flow rate. The tube 40 facilitates laminar flow to eliminate any sheer caused by any restriction caused by the outlet passage 38 and its associated coupling 39. Sheering causes dissolved gases to come out of solution which is undesirable.

It will be noted that central tube 20, the sleeve 26, the barrel 31 and the contents of the barrel are formed as a module, which can be removed from the stainless steel housing 1 by removing the clamps 12 for quick disassembly.

It will further be noted that one or more gasses can be introduced to the apparatus either sequentially or as a mixed gas. For example, oxygen may be introduced to the apparatus followed by introducing nitrogen to the apparatus. In such a manner, a fluid or liquid may be supersaturated with oxygen, held for a desirable time period, and the oxygen may then be displaced by subsequently supersaturating the oxygenated fluid with nitrogen.

With regard to the microporous structure, exemplary embodiments thereof may comprises a microporous hydrophobic hollow fibre membrane having a pore pathway diameter of about 0.01 μm to about 5 μm (hereinafter a “micromembrane”). Various embodiments of the microporous structure and micromembrane are described in U.S. Pat. Nos. 6,209,855 and 7,537,200, the entire contents of each of which are incorporated herein by reference.

Particular embodiments of the subject matter have been described. Other embodiments are within the scope of the following claims.

What is claimed is:

1. A mixing apparatus for saturating a liquid with a gas, the apparatus comprising:
a pressure tank having an internal volume;
a micromembrane structure within the internal volume of the pressure tank, the micromembrane configured to receive a gas under pressure;
a fluid within the pressure tank and in contact with an outer surface of the micromembrane;
a sump configured to receive the fluid such that the fluid is no longer in contact with the micro membrane.

2. The mixing apparatus of claim 1 wherein the pressure tank further comprises on or more fluid supply valves and one or more pressurized gas supply valves.

3. The mixing apparatus of claim 1 further comprising a gas discharge valve.

4. The mixing apparatus of claim 1 further comprising a sump for releasing unused gas from the fluid.

5. The mixing apparatus of claim 1 wherein the micromembrane comprises a pore pathway diameter of about 0.01 μm to about 5 μm.

6. The mixing apparatus of claim 1 configured to receive two or more gases under pressure.

7. The mixing apparatus of claim 4 further comprising a fluid discharge line in communication with the sump.

8. A method of mixing a gas and liquid comprising:
Introducing a liquid to an interior chamber of a gas/liquid mixture cylinder, wherein the gas/liquid mixture cylinder comprises a micromembrane within an inner chamber;
Introducing a pressurized gas to the micromembrane;
Transferring at least a portion of the pressurized gas from the micromembrane to the liquid until the liquid has a dissolved gas concentration of 10 ppm or more;
Holding the liquid in a sump within the mixture cylinder such that the liquid is not in contact with the micromembrane;
Removing the liquid from the sump.

9. The method of claim 8 wherein a the pressurized gas is displaced within the micromembrane with a second pressurized gas.

10. The method of claim 8 wherein the pressurized gas is oxygen, nitrogen, or carbon dioxide.
